(19) United States
(12) Patent Application Publication
(10) Pub. No.: US 2004/0162916 A1
(43) Pub. Date: Aug. 19, 2004

(54) Multiple use of identical names to identify different IP numerical addresses

(76) Inventor: William Kenneth Ryan, Lynchburg, VA (US)

Correspondence Address: Donavon Lee Favre, 1004 Druid Road East, Clearwater, FL, 33756, US

(21) Appl. No.: 10/780,359

(22) Filed: Feb. 17, 2004

Related U.S. Application Data
(63) Continuation-in-part of application No. 09/337,315, filed on Jun. 22, 1999, now Pat. No. 6,412,014.

(30) Foreign Application Priority Data
May 3, 2002 (WO) PCT/US02/14131

(51) Int. Cl. G06F 15/16

(52) U.S. Cl. 709/245; 709/226

(57) ABSTRACT

A numeric Internet Protocol directory or register is associated with each of a plurality of registered domain names on the Internet, so that any number of competitors, related goods and service providers or any other legitimate name owners be they family, trademark holders or registered companies can list in the associated directory or register under any of a plurality of top level domain names, descriptive names or any names of their choosing. The numeric Internet Protocol directory or register can also be a multi tiered structure based upon names independent of conventional domain names.

### CROSS-REFERENCE TO RELATED APPLICATIONS

For the purposes of a U.S. patent application filing, the present application is a continuation in part of allowed U.S. patent application, Ser. No. 09/337,315, filed Jun. 22, 1999, now U.S. Pat. No. 6,412,014 B1 Ryan (Jun. 25, 2002) the priority of which for U.S. purposes was claimed in International Application Number PCT/US02/14131 Ryan. Priority is also claimed of the filing date (3 May 2002) of International Application Number PCT/US02/14131 Ryan. The publication number of the PCT application is WO 03/094009 A1 (published 13 Nov. 2003).

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is directed to a method and apparatus for obtaining access to a numerical IP address.

The Internet can link your computer to any other computer connected to the Internet. The reason the Internet works is that every computer connected to it uses the same set of rules and procedures (known as protocols) to control timing and data format. The set of commands and timing specifications used by the Internet is called Transmission Control Protocol/Internet Protocol, universally abbreviated as TCP/IP.

The TCP/IP protocols include the specifications that identify individual computers and exchange data between computers.

Most computers are connected to local networks that connect through gateways to the Internet backbone. The core of the Internet is the set of backbone connections that tie the local networks together and the routing scheme that controls the way each piece of data finds its destination.

The Internet and its applications (e.g. www, e-mail, file transfer protocol) use an addressing system called the Domain Name System. This system translates an alphanumeric string such as “jones.com” into a numeric string, the IP address, which is the actual address to a network resource. While it is possible to address a resource directly with a combination of protocol type and address, the Domain Name System was devised to provide an intuitive addressing scheme. The “.com” level is called the Top Level Domain or TLD. The name before the TLD, in this case “jones”, in the example would represent a Second Level Domain or SLD. The term “domain name” is generally understood to be the combination of a TLD and a SLD. This is considered, for the purposes of the present patent application, as the conventional Domain Name System. Second level domains such as .co.uk and .com.au function as top level domains within their respective country code Top Level Domains and should be considered as such.

Internet activity can be defined as computers communicating with other computers using TCP/IP. The computer that originates a transaction must identify its intended destination with a unique address. Every computer on the Internet has a four-part numeric address, called the Internet Protocol address or IP address, which contains routing information that identifies its location. Each of the four parts is a number between 0 and 255, so an IP address looks like this: 128.243.117.214

It is much easier to remember and use the domain name than to type in the numeric string. The Domain Name System and its ability to address a resource “by name” will become even more important when Internet Protocol version 6 (IPv6) comes into use, since the numeric addresses in IPv6 are longer (128 bits in hexadecimal versus 32 bits in decimal). Computers have no trouble working with big strings of numbers like this, but humans are not so skilled. Therefore, most computers on the Internet (except the ones used exclusively for internal routing and switching) also have a host name, which is part of the Domain Name System (DNS). A host name is an address that uses words instead of numbers.

The Domain Name System is composed of a number of Top Level Domains. Fully qualified DNS names generally have an individual host name, followed by a top level domain name for a computer connected to the Internet that generally identifies the type of institution that uses the address, such as .com for commercial businesses or .edu for schools, colleges and universities. The University of Washington's DNS domain name is washington.edu, Microsoft's is microsoft.com.

Within the United States, the last letters of the domain name usually tell what type of institution owns the computer. Some large institutions and big corporations divide their domain addresses into subdomains. You might even see some sub-domains broken into sub-sub-domains.

Top Level Domains can also identify the country in which the system is located, such as .ca for Canada or .fr for France. Sometimes, a geographic domain name will also include a sub-domain that identifies the district within the larger domain. For example, va.us can indicate an Internet domain in Virginia and there is a commercial Internet service provider in the Canadian province of British Columbia called Mindlink. Its DNS domain name is mindlink.bc.ca.

The basic model for Internet tools is used for many functions: a client application on a user's computer requests information through the network from a domain name server, a powerful computer, containing a large memory, which acts as a shared storage resource. For example a user sends a domain name to the server, and the server returns the IP address, the four part numeric address, which is then used to contact the computer having that particular IP address.

Originally designed by an Internet ‘engineering task force’, the domain name system for TLD's has been handed over (by the US Government) to ICANN—the Internet Corporation for Assigned Names and Numbers—which has recently approved the addition of several new Top Level Domains (TLD's). National committees normally handle national Top Level Domains and national domain structures may differ from one another. For example, a commercial domain in Korea is registered as “xxx.co.kr”’ while an Australian registration would use the format “xxx.com.au” but Sweden has no special designation. Companies are registered as ‘xxx.se’. In each case, the ‘xxx’ must be unique within each domain and can represent a variable number of letters and/or numbers.

The problem is complex because the Domain Name System was created when the Internet was still young and (relatively) small, and when only a few major corporations and major universities were expected to have Internet connections. This bias is shown in other ways by e.g. the use of .gov to indicate only the United States government and .mil to designate only the United States military establishment. There was no TLD defined for individuals, although one has been opened very recently as “.name”.

Within each TLD or national domain there may be no more than one second level domain combined with the TLD such as ‘jones.com’ or ‘jones.net’ and allocation of these names normally has been on a first come, first served basis. People and companies have been allowed to register any name and any number of names, including generic descriptions, as long as these names have not already been claimed (registered) by someone else. Many violations of trademark and other property rights have been claimed. Registered names have been given Intellectual Property Right status, giving the owner exclusive, international rights to use that name as an identity in the Internet. The .com, .name, and national domains are the ones potentially most impacted by the need for ‘exclusivity’. Although 2 or more people or companies may have equally legitimate rights to a name, only one is allowed to use it on the Internet. An example is Apple, which may be the music publishing company founded by the Beatles, or the computer company founded by Steve Jobs, or maybe some organic produce company. Only one can identify itself as “apple.com”. There are at least 3 companies named Amazon in New York City. There are approximately 100 companies in California named “Great Wall”. Only one company on the Internet can identify itself as “plumber.com”, giving that company exclusive international rights to identify itself with the generic term.

There are also examples of misrepresentation and “namenapping”, and the supply of available, appropriate names especially within the .com TLD is rapidly diminishing. This situation is patently unfair and contrary to previous International Property Right concepts. Unlike the telephone system, which is based on all-to-all communication, the Internet is almost feudal with a ‘landed gentry’ owning the resources for creating and distributing information. The populace, both as individuals and as society in general, would be better served by the communications technology of the Internet if these problems were resolved.

The above general information concerning the Internet was taken in part from COMPUTING FUNDAMENTALS, Second Edition, pages 295 to 297 by Peter Norton, published by Glencoe McGraw-Hill (1987).

As outlined above, a problem with the Internet is that each domain name (individual name plus top level domain) is unique, and duplicates are not allowed. Various companies have the same name but deal in different types of goods, but only the first company that registers on a top level domain is allowed to use that name, giving that particular company a monopoly on a name. The same is true with Trademarked goods. The same Trademark is used by different companies on different types of goods, but only the first company to register the name on a domain is allowed to use the Trademark as a domain name. This makes finding a company by its name or the name of the product that it produces or the service that it provides difficult using domain names.

One solution to the problem involves setting up an independent registry for “nicknames” as disclosed in the following patent.

U.S. Pat. No. 5,764,906 Edelstein et al (1998) at the abstract discloses the following. “A universal electronic delivery system allows a user to locate information on a distributed computer system or network such as the Internet by knowing or guessing a short mnemonic alias of an electronic resource without the user having to know the physical or other location denotation such as the universal resource locator (URL) of the desired resource. The system hardware includes a client computer, a local server, a central registry server, a value added server, and a root server. The universal electronic resource denotation, request and delivery system supports a personal aliasing (nicknaming) feature, a universal resource accessing feature for finding location information such as URL's relating to a query term, a “see also” feature for including information about related documents or resources within the record of a resource, a feature for updating local servers and client machines by periodically deleting those records which have changed, a “try again” and “mirroring” feature for aiding a user in obtaining the resource under adverse hardware or software conditions, and an authentication and administration feature that allows a user to administer the aliases and related data which pertain to his/her resources.” At col. 13, lines 24-63, Edelstein discloses, “FIG. 6 depicts the organization of the dual implementation of the preferred embodiment of this invention. In this implementation, the client system 603 provides the user with the choice of whether to prefer the Local or the Wide Area or Global (Internet) interpretations of Resource Aliases. This Reference guides the local server 604 to search for a Resource alias or character string purported to be a Resource Alias first in its Local Registry 606 or first in the Global System 605. If the preferred choice fails to match a Resource Alias, the secondary system (for that particular user) search is activated. Thus, each client request is accompanied by system preference data. The Client User interface in displaying lists of Resource Aliases or individual Resource Aliases and their associated Records, also displays whether that particular Resource Alias and Record are Local or Global (Wide Area or Internet). The local Server 604 is advantageously linked with the Central Registry or Root Server and Value Added Services, 607 of the Wide Area System.”

INTERNET ONE of the British Indian Ocean Territory has a practice, which is even more monopolistic against residents of the territory than the other national Internet organizations. Residents are forced to register as “name”.com.io, a third level domain. Other registrants are allowed to register domain names on a first come, first registered basis, with a directory of non .io domain names replacing the first registration for duplicate names. The directory for non .io names contains the domain name and the non .io IP address of each registrant in the directory. Also, the registration of duplicate names is restricted. For example “Spicegirls.io” is limited to one registration.

One system similar to INTERNET ONE is www.new.net <http://www.new.net>—a competitor to ICANN using a proprietary solution for providing additional top domains. They create additional, fictive TLD's by using the format: name.new_domain{new.net}. For example they would allow you to register as ‘favre.law’ but then require users to either 1) reach you through a cooperating ISP or 2) add ‘plug-in’ software to their web browser. Otherwise you would see the real registration: favre.law.new.net. The improvement over INTERNET ONE is that New Net has software that suppresses (hides) the ‘new.net’ domain name.

Intellectual Property and Privacy Issues on the Internet, McDonald et al. JPOS, p. 47 (January 1997) discloses, “Some commentators have suggested providing “sub-domains” within the “.com” system for types of goods and services or by geographic area, in a manner akin to Yellow Page Listings. - - - However, developments do not appear imminent, - - - “.

CYBERMARKS: A PROPOSED HIERARCHICAL MODELING SYSTEM OF REGISTRATION AND INTERNET ARCHITECTURE FOR DOMAIN NAMES, G. Andrew Barger, The John Marshall Law Review, Vol 29, p. 656, 659 (1996) suggests International, Country, State and County directories, but only one unique name per directory.

Along the same lines is: A SOLUTION TO THE PROBLEM? TRADEMARK INFRINGEMENT AND DILUTION BY DOMAIN NAMES: BRINGING THE CYBERWORLD IN LINE WITH THE “REAL” WORLD, Jennifer R. Dupre, Vol. 87 TMR, pps, 629-637. Dupre proposes a system of replacing a domain name with a directory as soon as a request for a registration of a duplicate of the domain name is filed. If implemented, this could be considered an encroachment on the exclusive rights of the owner of the domain name, particularly if the owner of the domain name also owns a trademark in the domain name.

GATEWAY PAGES: A SOLUTION TO THE DOMAIN NAME CONFLICT? By Puneet Singh, Vol. 91 TMR, p. 1234 discloses “If more than one party sought to register the identical domain name, a directory would be created for that specific domain name, and that domain name would no longer be unique.”

A PROPOSAL FOR THE REGISTRATION OF DOMAIN NAMES, Michael A. Sartori, Vol. 87 TMR, p. 638, 653-656 at page 638 discloses a system “ - - - based on the premise of eliminating the uniqueness of domain names”.

U.S. Pat. 5,410,691 Taylor (1995) may be of interest in its organization of a network database. The Patent discloses at the abstract, “The network database is arranged in a plurality of domains in a logical hierarchy. Each domain of the hierarchy represents a body of information associated with a logically related group of users or related group of computers. A relative naming scheme is implemented in which a domain stores the names of only its parent domain and child domains. This permits reconfiguration of the network to be accomplished without changing the database structure. Each domain stores information in a hierarchical structure known as a “directory” Each directory consists of a list of zero or more “properties,” each having an associated name and ordered list of values.”

U.S. Pat. No. 5,832,498 of Exertier, Nov. 3, 1998 discloses at the Abstract,

“A device and process for generating object-oriented interfaces (GEN) for authorizing new applications (OOA) developed in object-oriented environments to access existing relational data bases (RDB). The device (GEN) creates, according to a process for generating object-oriented interfaces from the schema of the relational data base, an object schema which constitutes an object-oriented view of the existing relational data base (RDB), this view, which constitutes the object-oriented interface (OOI), being composed of a set of classes which represent the entities stored in the data base. The input applied to the interface generation device is the data base description (DBD) in a standard language for defining and manipulating data.

U.S. Pat. No. 6,167,449, Arnold, et al. Dec. 26, 2000, discloses at the Abstract,

“A computer-implemented method and apparatus for identifying and locating computer network services. The invention gives an application the ability to search for network services in a manner independent of the network communication protocol used by the network. The invention can thus operate as a layer of abstraction between the Transport and Network Layers and the Application Layer of the Open Systems Interconnect (OSI) Reference Model of network architecture and suite of protocols. The invention gives the client application the ability to browse for network services based on the type of service (such as remote file access, mail, Web, domain name registration, etc.), rather than having to know the name or location of the service or the underlying network communication protocol used by the service. Some of the contemplated service name identification protocols used to find the requested types of services include Internet-related protocols such as Domain Name Service (DNS) and Lightweight Directory Access Protocol (LDAP), as well as Service Location Protocol (SLP), running on top of the Transport Control Protocol/Internet Protocol (TCP/IP).

### BRIEF SUMMARY OF THE INVENTION

The system of using a name plus a qualifier works very well. The TLD “.com” and the other TLD's have quickly become part of the popular culture. This convenience can be maintained, while resolving the identified problems by extending the domain name system by the addition of a directory structure and allowing multiple registrations of the same name or related names in a single Top Level Domain directory.

The present invention is directed to an improvement in a national or other top level Internet registry system for example .com, .net, .org, .name etc which allows nationals to register a domain name resulting in a plurality of registered domain names. The improvement comprises a directory associated with each of a plurality of domain names in the DNS, the associated directory containing a collection of names and information concerning owners of names identical, similar to or related to the domain name. The associated directory can be a directory, and/or a sub-directory, and/or a sub-sub-directory and even broken down into further subs. The numeric IP address is a numeric IP address of an associated directory separate from the numeric IP address of the domain name. The information in the numeric IP address of each associated directory includes the unique numeric Internet (IP) address if available of each of one or more owners and information concerning each of the owners of identical and similar names listed in each directory. By the owner of a name is meant an entity having a legal right to use a particular name such as a family name, a business name, a trademark, a service mark or any legalized right to use a particular name. The numeric IP addresses of the listings in the associated directory are “associated IP addresses of associated domain names”.

Under this plan, if only one “Jones.com” is registered in the Internet, the domain name system would work as it does now, translating the name into an IP address. As soon as a second registration for “Jones.com” is filed, the DNS would, at the option of the user, serve up an associated directory list providing additional information about each new entry such as location, telephone/fax numbers, type of business, name of registered owner, or “anonymous” which also provides relevant information to the user. The directory can include Internet specific information such as relative traffic intensity to each site, etc. The original “Jones.com” domain name would be left unchanged. Thus, unlike the prior art, the original domain name will not be taken and converted into a directory, nor a user involuntarily directed away from a trademarked domain name to a competitor. The present invention does provide for competitive advertising should the user want to look at competitors' sites.

Each jones.com entry in the associated directory (or data base) translates to a unique IP address. The user selects the appropriate destination (makes the ‘which Jones’ selection) from the associated directory, or can search the directory for an element or combination of elements such as ‘plumber’ and ‘Toledo, Ohio’. The selected entry translates to the unique numeric IP address of the requested resource on the Internet. These numeric IP addresses work exactly as they do today. Currently the translation from name to number is automated; there is a one-to-one relationship. The present solution inserts a selection point supporting a one (name) to any-one-of-many (numbers) relationship. This is what we do manually when we select one Jones from many listed in the telephone directory. As a result, any legitimate name can be registered more than once, and the concept of ‘legitimate’ can be retired. If an owner of a right to a name “Jones” wishes to register a ‘jones.com’ on the Internet why shouldn't the owner be allowed to do so. An owner can do it now after all, as long as jones.com isn't already registered. The present problem of namenapping would be significantly reduced. A non-owner of a name could not exclude a name owner from registering and therefore most names could not be held for ransom. This would avoid costly litigation. The ability of a name owner to register the owner's name on the Internet would encourage additional registrations, especially among those who are now ‘locked out’, and this would increase the total value of the Internet for all users.

The present invention will prompt collateral invention and development. The normal rules of society (against diluting trademarks, defamation, illegal impersonation, etc.) will still apply, and there will be less need to create new regulation to apply only to this one communications medium.

The present invention can be applied to any and/or all top level and national domains, as determined by the national or international organizations responsible for them. If for some reason the known top level domains, based upon the type of activity are removed in favor of a greater number of new top level domains based on what are currently considered second level domain names, e.g. if domain name jones.com were simplified to jones, these new top level domains will be defined as second level domains or different registered domain names for the purposes of this patent.

The Internet should not be recognized as a system for preempting a family name or the right of an entity to capitalize on a name that the owner entity has established as an indication of quality goods or quality services and relinquish the right either to the first to register or to an opportunist who recognizes the value of a name and registers it to extort money from those who put value into the name.

The associated directory can if desired have one or more sub directories broken down in any known manner containing the names and IP addresses of the owners of similar names and information concerning the owners of similar names, or such names can be contained in the associated directory.

The associated directory can if desired contain a sub directory for a listing of the names and IP addresses of entities supplying goods or services relating to or supportive of one of the entities in the national or top level domain.

The IP address is not required in any event for a listing in the associated directory as a company may only list a phone number or a postal address, but the majority of legitimate businesses have or in the future will have an IP address. A requirement should be made that any entity doing business on the Internet should have a traceable geographic address, business type, or some other identifier, which when used in combination with the sub-directory name will render that listing unique when viewed with other listing in the associated directory.

The present move by the Internet system to add more top level domains such as store and .web will not, in many cases, increase the opportunity for entities to register, because those already registered will ensure duplicate registrations by registering first or squatters will register first with the hope of extracting substantial amounts of money from those entities who by creating valuable goods or services, put value in a name.

The present invention solves the monopolistic problem of allowing only unique registration of a specific domain name to each top level domain or a nickname on a single registry to a single company or restricting nationals from registering a top level domain name. The problem is solved by associating a directory with each domain name so that any company providing related goods are services can advertise in the associated directory regardless of their domain name or numerical Internet address. The directory does not have to contain any information, merely be available in case any entity wishes a listing. In addition, any individual, organization or institution can obtain a listing in a domain name directory of their choice. It is not necessary that the entity obtaining the listing even have a numerical Internet address. A postal address, a phone number or any other information that the entity wishes to provide could be accepted including political, and religious advertising with no source indication.

In the database technology foreseen to implement the present invention, each directory and sub-directory can in fact be no more than a number of separate records or columns in a single database, or in multiple or distributed databases.

### BRIEF DESCRIPTION OF THE SEVERAL VIEWS OF THE DRAWINGS

FIG. 1 shows the route taken to obtain related domain names, and/or addresses and/or phone numbers and/or business names and/or business types.

FIG. 2 shows an Internet directory service allowing multiple registrations of the same or related domain names that can be used without changing the basic Internet Domain Name Structure.

FIG. 3 shows another embodiment of the present invention would replace the domain name system by utilizing a name-tree structure.

### DETAILED DESCRIPTION OF THE INVENTION

### Example 1

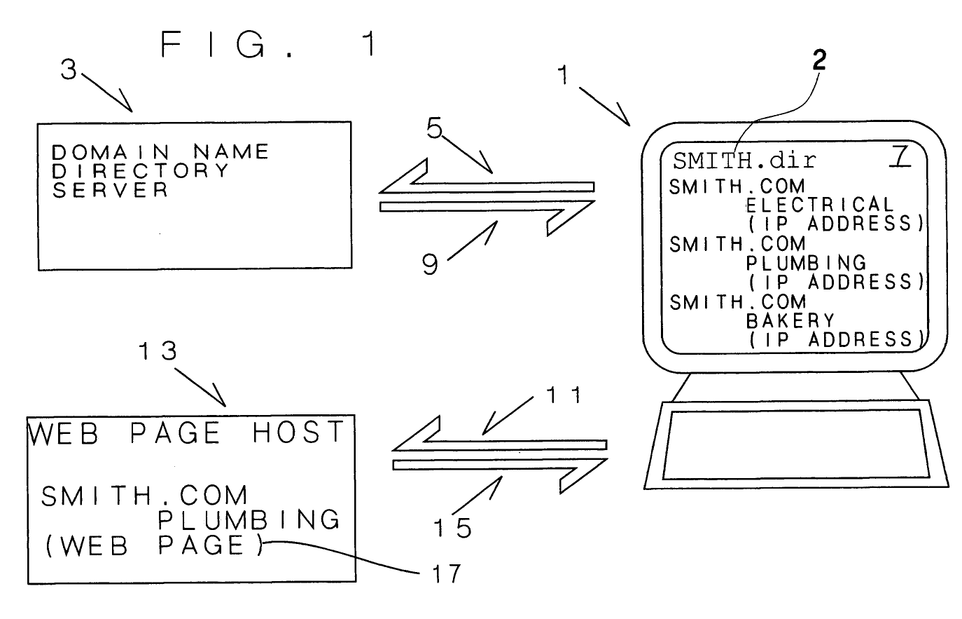

How to find a name related to a domain name will be described with reference to FIG. 1. A users computer 1 is connected to the Internet. The computer 1 accesses domain name directory server 3 through a communication line 5. When a known or anticipated domain name is requested from the domain name server 3, the domain name server returns a unique address of one registered domain name. At the option of the user, an associated directory listing 7 can be accessed if several domain names with separate numeric IP addresses are registered in the associated directory 2. For example if the user knew the domain name was “Smith”, the user could enter “Smith.dir”2. The domain name server 3 then supplies a listing of the names and associated information which constitute the associated directory “Smith.dir”2 and the listings 7 and the corresponding associated numeric address (IP address) corresponding to each associated name in the “Smith.dir” directory 2 by return communication line 9. The listing 7 would contain a number of “Smith.com” and related listings along with sufficient information concerning each listing, that user could choose which “Smith.com” or related listing that the user was searching for. The associated directory listing 7 would contain for each associated entity entry, for example, the type of activity the entity was engaged in, the geographical location of the entity, the IP address, the business name, the business type, and/or any other information that the entity wanted or needed to include to distinguish that particular entity from the other listings. The above description is simplified and describes the application of the present invention to the version of the Internet presently in use. The present invention can also be used in future IP versions, which may have a different structure.

The associated directory listing 7 returned to the user at computer 1 is preferably an Internet web page, and each associated directory entry is a hyperlink to the corresponding associated numeric IP address of the respective associated directory entry. By selecting the desired “smith.com” from the associated directory list (for example by “clicking” on the hyperlink), the user by computer 1 uses the associated IP address and sends a request through communication line 11 to the Web page host 13 containing the associated IP address listed for that particular Smith listed in listing 7, and by return line 15 receives the information contained in that particular Smith's web page 17.

The directory is separated from the domain name. This requires two separate numeric IP addresses. One numeric IP address for the domain name registered under the current registration system and a second numeric IP address for the associated directory 2 containing names related to the domain name.

As the domain name directory is separate from the domain name, a request is placed for an associated domain name directory 2 corresponding to a known domain name. An associated directory 2 is associated with each non-unique alpha-numeric domain name having one or more listings. The associated directory 2 can be accessed using a domain name without the .xxx or followed by a “/dir” or a “.dir”, such as “{domain name}/dir” or “{domain name}.dir” or a similar known access means. The associated directory 2 is accessed using an Internet numeric IP disassociated with the domain name numeric IP. The present invention contemplates the creation of one or more top level domains that do not follow the current pattern, and are used for e.g. directory functions such as described above or for family name directories.

The listings in the associated directory can be broken down into separate listings for entities having an IP address.

The listings in the associated directory can be ranked in order of the frequency of selection, or by business type, post office address, e-mail address or telephone area code. In the case of post office address, or telephone area code, no IP address is required.

Another advantage of the present system is that competitors of the owner of the domain name can advertise in an associated directory under the domain name, providing comparative advertising and reducing to some extent the overreaching monopoly rights in the domain name.

Associated directory 2 contains a separate listing 7 associated with each of a plurality of domain names, so that any company providing related goods or services can advertise in the associated directory 2 regardless of their domain name or numerical Internet address at the discretion of the national or international registration organization. In addition, any individual, organization or institution can obtain a listing in an associated domain name directory 2 of their choice. It is not necessary that the entity obtaining the listing even have a numerical Internet address. A postal address, a phone number or any other information that the entity wishes to provide will be accepted including political, and religious advertising with no source indication, again at the discretion of the national or international registration organization.

The term “national domain name” excludes the registry of names of nationals in a registry such as the Indian Ocean registry where nationals are required to register in a collective registry.

Not all domain names will have an associated directory 2 containing listings of other domain names. Some domain name owners will be reluctant to allow such a practice, and some non-domain name owners will be reluctant to list a name in a directory containing a competitor's name

One method of implementing the above procedure is set forth in RFC1035. The existing DNS standard contains a structure of unused records for each domain name that could be expropriated for new uses. Thus, although non-unique domain names have not been contemplated in the domain name system, the construction of the system would allow the use of a resource record to flag “yes” instead of “no” (or null) to indicate the existence of a non-unique domain name. This could trigger a stop in the automatic translation a domain name to a numerical IP address and spawn a separate process to present a directory of identical domain names plus additional distinguishing information from which the user can make a selection. This would de-automate the process that dictates a one-to-one relationship between a domain name and a numerical IP address when more than one instance of the same domain name is registered. One way to spawn a separate process is to return to the user the IP address of a web page presentation of a database containing the domain name and related information (qualifiers), in which this distinguishing information is represented as hyperlinks to the separate IP addresses for each of the non-unique domain names.

### Example 2

In another embodiment the present invention is directed to an application that allows a registry or group of registrars, a single Internet Service Provider, or a cooperating group, to provide an Internet directory service allowing multiple registrations of the same domain name that can be used without changing the basic Internet Domain Name Structure, and build an HTML-accessible database in which the unique key to each numeric IP address is a domain name-like identifier including a character not normally used in domain names, e.g. the # character. It would be possible to suppress the display of this character and following characters in the software, such as is done in the “new.net’ program discussed in the Background Art. The organization of this embodiment is as follows:

TABLE I

| Domain | Physical | | | | |
|---|---|---|---|---|---|
| name | addr. | Phone | Business | key | IP address |
| smith.com | New York | 123 456 | banking | smith | 123.156.189.012 |
| smith.com | London | 789 012 | baking | smith#1 | 145.178.101.234 |
| smith.com | Paris | 345 678 | plumbing | smith#2 | 167.190.123.156 |

User selection (clicking) any field in the same row would select the unique IP address for a web site. For line mode applications such as e-mail and file transfer, where no directory page is displayed, the key could be used explicitly as the domain name. For example ‘smith.com’ in New York would use xxx@smith.com <mailto:xxx@smith.com> for e-mail, while ‘smith.com’ in Paris would use xxx@smith#2.com <mailto:xxx@smith#2.com> for e-mail. This would allow users registered natively in the DNS, “original name holders”, to continue using their ‘old’ e-mail addresses while providing appropriate addresses for “new name holders”. Many companies already use different web domain names and e-mail addresses. In a table as above, the ‘key’ could be named e.g. the ‘e-mail domain’.

The embodiments provide the use of the IP address as a unique sorting key, different for each entity sharing some similar attribute such as domain name ‘jim.name’ in the Internet. This idea would work when applied to any or all Top Level Domains in the Internet for example the generic TLD's such as ‘.com’, or a country code TLD's such as ‘.jp’.

The embodiment of Example 2 goes a little further, since it introduces a new, unique ‘quasi’ domain name which would allow registration of ostensibly identical domain names by one or more (preferably cooperating) Internet Service Providers and/or registrars, without requiring an entire TLD to adopt the change. In this way it is similar to the New Net concept, with the advantage that it does not require the introduction of new, fictive TLD designations such as ‘.kids’ or ‘.shop’. The very familiar and popular ‘.com’ designation can be used, since the new listing would not collide with existing ones. This idea also solves potential problems by making an appropriate e-mail and/or file transfer domain name available for applications that would not generally provide a ‘web page like’ selection menu to the end user, and it maintains the integrity of e.g. existing hypertext links in stored content and search engine/directory systems.

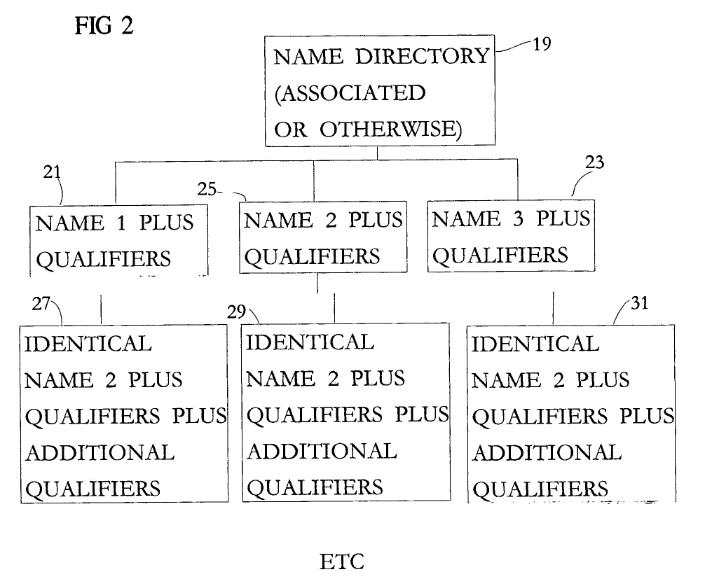

FIG. 2 shows the organization of the directory of names, associated or otherwise. Any name can be used in this directory. All that is required is that the name in combination with its qualifiers be different from any other name in combination with its qualifier which has been assigned a numeric IP address. Any national or international authority can assign a numeric IP address to the different name plus qualifier combination. FIG. 2 shows a NAME DIRECTORY 19 which can contain up to all of the names on the Internet. The user chooses a name from DIRECTORY 19, and is then presented with a listing of registrations of that name in combination with distinguishing qualifiers, see 21, 25 and 23. In the instance where there are duplicate qualifiers such as Smith Bakery in London, a sub-directory 25 is provided which provides sub-sub-directories having additional qualifiers as Smith Bakery Products 27, Smith Bakery Supplies 29, Smith Bakery Sales 31 and any additional qualifiers to distinguish one Smith Bakery from another. If there are still duplicate entries in the same sub-sub-directory, sub-sub-sub-directories can be established and so on until all of the Smith Bakery companies can be distinguished from one another.

In this manner, any entity who wishes to have an Internet IP address can have one. All the entity needs is a unique identifier in combination with the entity name. An additional advantage of this system is that it informs a user about the goods or services of the entity. An entity can be as specific as it wishes in identifying its goods and services and as general as it chooses.

Another way of distinguishing domain names from each other is by use of International Domain Name (IDN) characters positioned anywhere inside of the domain name.

Another way of distinguishing domain names from each other is by use of scripts that translate ‘odd’ characters into the limited ASCII characters of the Domain Name System and then back again. The scripts have been developed by the Internet Engineering Task Force (IETF).

### Example 3

The domain name system of the present invention discussed above utilizes a strictly hierarchical directory structure. Another embodiment of the present invention would replace and/or extend the domain name system by utilizing a name-tree structure. One example of a name-tree structure, the Intentional Naming System, is described by the Laboratory for Computer Science at MIT in Operating Systems Review, 34(5):186-201, December 1999. A name-tree structure allows several instances of non-unique entries, each further qualified by additional attributes. One advantage of applying an automated name-tree directory structure is that a user may request e.g. ‘jones.com’ and receive a directory listing of available jones.com domain names with sufficient additional information to make the ‘which jones’ selection.

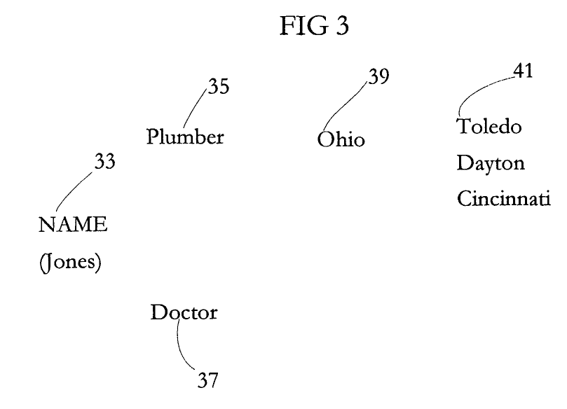

Turning now to FIG. 3, The name tree is characterized by a register 33 for any name an applicant wishes to register. One or more additional registers 35, 37, 39 and 41 are used for qualifiers which qualifiers in combination with the name, distinguish the registration from all previous registrations. Each move to the right in the name tree directory of FIG. 3 further specifies the entity to its left. The registers 33+ are arranged in a tree structure. For example if the registered name is “Jones”, and there is more than one “Jones”, the second level register is presented asking “which Jones, plumber 35 or doctor 37”? If plumber is selected and there are more than one “plumber Jones”, the third level 39 is presented requesting state 39 and then city 41 and so on.

The name on the register could be a name for specialized goods or services, and each qualifier could make the goods or services more specific and in addition identify the source of the goods or services. In practically all cases a numeric IP address is furnished by the directory tree system.

Instead of going through the name tree in sequence, the entire name tree for a given name can be exposed, and a user can select the desired IP address. Another approach is to search the name tree using boolean operators. The name tree will be designed by suppliers of goods and services who will be able to provide the right register content for a potential customer or client to find the registrants IP address. Searching through a name tree will educate a user as to what is available.

However if the user requests a document by full URL (Uniform Resource Locator—the protocol type, domain name and file name and type) under the present system, such as http://www.jones.com/welcome.html and that URL is unique among the jones.com domains, the requested file will be delivered without requiring an intermediary (‘which jones’) directory selection.

Although the current system of top level domains provides a good first qualifier both conceptually and in a hierarchical naming system, the invention anticipates that increases in processor power coupled with lower costs for memory devices and other technological advances in networked communication will eliminate the need for TLD's, allowing SLD's alone to act as domain names in combination with qualifiers. Any national or international registration authority can then register any name in combination with the necessary qualifiers to render the combination unique. In addition, it is anticipated that the invention of Arnold, et al, (discussed above) or other service discovery and application layer services in the Internet could utilize the invention. In addition when two top level components are combined such as .co.uk, the two top level components are considered as a top level component or TLD.

The present invention will allow any industrial organization to acquire an associated name on the Internet and advertise its goods and services, even though the name has been taken under the present registration scheme as a domain name. The present invention allows multiple use of identical names on the Internet to identify different resources.

I claim:

1. In a national or other top level Internet registry system which allows nationals to register a different domain name resulting in a plurality of different registered domain names, the improvement characterized by:
a) an associated directory under each of a plurality of the different domain names in addition to and not replacing the plurality of different registered domain names,
b) the numeric Internet Protocol (IP) address of the associated directory being separate from the numeric Internet Protocol address of a corresponding different domain name, the numeric IP address of the corresponding different domain name remaining unchanged, and
c) a collection of one or more associated domain names and information concerning the owner or owners of each of the associated domain names contained in each associated directory.

2. The Internet system of claim 1 wherein each of a plurality of associated directories optionally includes the corresponding domain name of an owner or owners of the corresponding different domain name and includes an IP address of each of the secondary domain owners.

3. The Internet system of claim 1 wherein each of a plurality of associated directories contains one or more associated mnemonic domain names identical to the plurality of registered mnemonic domain names.

4. The Internet system of claim 1 further characterized by a separate listing of associated domain names with an IP address.

5. The Internet system of claim 1 further characterized by the associated domain names ranked in the order of frequency of selection.

6. The Internet system of claim 1 further characterized by the associated domain names listed by post office address.

7. The Internet system of claim 1 further characterized by the associated domain names listed by telephone area code and telephone number.

8. The Internet system of claim 1 further characterized by the associated domain names listed by type of business.

9. In a national or other top level Internet registry system, the improvement characterized by a plurality of multi tiered directories containing names in combination with information concerning the owner or owners of names contained in each of the directories instead of and not replacing mnemonic domain names.

10. The Internet system of claim 9 wherein each of a plurality of multi tiered directories contain the name, address, phone number, type of business and e-mail address of an owner or owners of each name contained in each of the directories.

11. In an Internet registry system which allows nationals to register primary domain names, the improvement characterized by:
a) a sub-directories containing a listings of a plurality of associated second level domain names (SLDs) corresponding to SLDs of registered domain names, each of the plurality of listings constituting an associated sub-directory, and
b) a collection of names and information concerning each associated SLD contained in each associated sub-directory, the IP address of each sub-directory being separate from the IP address of the corresponding domain name, which IP address of each corresponding domain name remains unchanged.

12. The Internet system of claim 11 wherein each of a plurality of associated sub-directories includes an associated domain name of an owner or owners of an associated domain name and an IP address of each of the secondary domain name owners.

13. The Internet system of claim 11 wherein each of a plurality of associated sub-directories contains one or more SLD names identical to the SLD of a corresponding domain name.

14. The Internet system of claim 11 further characterized by a separate listing of associated second level domain names with an IP address.

15. The Internet system of claim 11 further characterized by the associated second level domain names ranked in the order of frequency of selection.

16. The Internet system of claim 11 further characterized by the associated second level domain names listed by post office address.

17. The Internet system of claim 11 further characterized by the associated second level domain names listed by telephone area code and telephone number.

18. The Internet system of claim 11 further characterized by the associated second level domain names listed by type of business.

19. The Internet system of claim 11 wherein each of a plurality of associated sub-directories includes an associated sub-sub-directory.

20. An Internet registration system having a basic Internet domain name structure characterized by:
a) a register for any name an applicant wishes to register without changing the basic Internet domain name structure,
b) one or more registers for qualifiers, which qualifiers in combination with the name distinguish the registration from all previous registrations of the same name, whereby multiple uses of identical names to identify different resources can be employed.

21. The registration system of claim 20 further characterized by the registered name being a name that the registrant has a legal right to use.

22. The registration system of claim 20 further characterized by the registers being arranged in a tree structure, each name-tree structure containing several instances of non-unique entries, each entry further qualified by additional attributes.

23. In an Internet registry system containing conventional domain names in a directory, each conventional domain name having a top level domain component and a second level domain component, the improvement characterized by
a) the addition of one or more duplicate added second level domain names and
b) the addition of one or more characters and/or ordinals anywhere in each added second level domain name to create new domain names, all different, the added characters not forming conventional names, and without changing the original domain name.

24. The Internet registry system of claim 23 wherein the new domain names are contained in a directory wherein the improvement is further characterized by the directory containing sufficient information about each new added domain name to aid a user in the selection of the desired new added domain name.

25. The Internet registry system of claim 23 wherein the display of the view of the characters and/or ordinals is suppressed.

26. The Internet registry system of claim 23 wherein the characters and/or ordinals consist of one character and one ordinal.

27. The Internet registry of claim 23 wherein the characters and/or ordinals consist of ordinals.

28. In an Internet registry system having a plurality of different registered domain names, the improvement characterized by:
a) a resource to indicate the existence of a non-unique domain name,
b) a stop in an automatic translation of a domain name to a numeric IP address, and
c) a spawning of a separate process to present a sub-directory of identical domain names plus additional distinguishing information from which a user can make a selection, the non-unique domain names being in addition to and not replacing the plurality of different registered domain names, which different registered domain names retain their original IP address.

29. The Internet registry system of claim 28 further characterized by a user registering a domain name plus one or more qualifiers.

30. The Internet registry system of claim 29 further characterized by the one or more qualifiers comprise characters and/or ordinals.

31. The Internet registry system of claim 28 further characterized by the one or more qualifiers comprising unique information concerning the user.

32. In an Internet registry system, the improvement characterized by:
a) an associated directory available under each of a plurality of registered domain names, but not replacing the registered domain names, or their respective numerical IP addresses, and
b) a collection of one or more associated domain names and information concerning the owner or owners of each associated domain name contained in each associated directory
